(19) United States
(12) Patent Application Publication
(10) Pub. No.: US 2021/0286571 A1
(43) Pub. Date: Sep. 16, 2021

(54) PRINT MANAGEMENT APPARATUS CAPABLE OF DETERMINING PRINTING SPOILAGE AND NON-TRANSITORY COMPUTER READABLE MEDIUM FOR STORING PROGRAM FOR PRINT MANAGEMENT

(71) Applicant: FUJIFILM Business Innovation Corp., Tokyo (JP)

(72) Inventors: Takashi BETSUYAKU, Kanagawa (JP); Hisao KOMAZAWA, Kanagawa (JP); Kentaro IKEDA, Kanagawa (JP); Kodai SUZUKI, Kanagawa (JP)

(73) Assignee: FUJIFILM Business Innovation Corp., Tokyo (JP)

(21) Appl. No.: 16/940,398

(22) Filed: Jul. 28, 2020

(30) Foreign Application Priority Data
Mar. 13, 2020 (JP) 2020-044460

(51) Int. Cl. G06F 3/12

(52) U.S. Cl. CPC G06F 3/1241; G06F 3/1251; G06F 3/1219; G06F 3/1235

(57) ABSTRACT

A print management apparatus includes a processor. When a job is divided into multiple divisions due to suspension of printing of the job, which occurs while a printer configured to perform printing on a continuous sheet prints the job on the continuous sheet, the processor outputs the amount of spoilage for a first division, which is a division before the suspension, of the job. When a second division, which is a division after the suspension, of the job is printed, the processor outputs, as the amount of spoilage for the job, the total of the amount of spoilage for the second division and the amount of spoilage for the first division.

### CROSS-REFERENCE TO RELATED APPLICATIONS

This application is based on and claims priority under 35 USC 119 from Japanese Patent Application No. 2020-044460 filed Mar. 13, 2020.

### BACKGROUND

### (i) Technical Field

The present disclosure relates to a print management apparatus and a non-transitory computer readable medium.

### (ii) Related Art

For example, Japanese Patent No. 5770580 describes a print sequence determination apparatus, which determines the print sequence of multiple print jobs on a single unit of print sheet, in a print system having multiple print settings or multiple post-processing settings. The print sequence determination apparatus includes a spoilage-amount storage unit and an input data storage unit. The spoilage-amount storage unit stores, in advance, the amounts of spoilage parts of the sheet (hereinafter referred to as “the amounts of spoilage”) which are produced when each print setting is changed to a different print setting, or the amounts of spoilage which are produced when each post-processing setting is changed to a different post-processing setting. The input data storage unit stores multiple pieces of input data, each of which includes a print sheet type, a print specification, a post-processing specification, and print image data. The print sequence determination apparatus also includes a computation unit that performs steps a) to c) on multiple pieces of common-sheet-type input data, having a common print sheet type, among the pieces of input data so as to determine the print sequence of multiple print jobs, which is generated from the pieces of common-sheet-type input data. In step a), for one print sequence of the pieces of common-sheet-type input data, the amount of spoilage is obtained from the spoilage-amount storage unit either on the basis of the print settings of the print system corresponding to the print specifications of each pair, whose pieces are adjacent to each other in the print sequence, of the common-sheet-type input data, or on the basis of the post-processing settings of the print system corresponding to the post-processing specifications of each pair of the common-sheet-type input data. In step b), the total amount of spoilage, which is the total of the amounts of spoilage of the multiple pieces of common-sheet-type input data, is obtained. In step c), the print sequence, whose total amount of spoilage is minimum, is obtained by performing step a) and step b) on each print sequence of the multiple pieces of common-sheet-type input data.

Japanese Unexamined Patent Application Publication No. 2017-207597 describes an image forming apparatus which provides information about the schedule of use of a continuous sheet in execution of jobs. The image forming apparatus includes a transport unit, an image forming unit, a job selection unit, and a controller. The transport unit transports the continuous sheet. The image forming unit forms images on the continuous sheet transported by the transport unit. The job selection unit selects jobs that are to be done. The controller calculates the image formation distance indicating the length, which is necessary for execution of the selected jobs, in the transport direction of the continuous sheet, and causes a display unit to display the calculated image formation distance.

Suspension of printing of a job on a continuous sheet causes the job to be divided, and spoilage is determined only for each division. Accordingly, it is desirable to determine the amount of spoilage for each job even when printing of a job is suspended.

### SUMMARY

Aspects of non-limiting embodiments of the present disclosure relate to a print management apparatus and a non-transitory computer readable medium which enable the amount of produced spoilage to be determined for each job even when printing of a job on a continuous sheet is suspended.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a print management apparatus including a processor. When a job is divided into multiple divisions due to suspension of printing of the job, which occurs while a printer configured to perform printing on a continuous sheet prints the job on the continuous sheet, the processor outputs the amount of spoilage for a first division, which is a division before the suspension, of the job. When a second division, which is a division after the suspension, of the job is printed, the processor outputs, as the amount of spoilage for the job, the total of the amount of spoilage for the second division and the amount of spoilage for the first division.

### BRIEF DESCRIPTION OF THE DRAWINGS

Exemplary embodiments of the present disclosure will be described in detail based on the following figures, wherein:

FIG. 1 is a diagram illustrating an exemplary configuration of a print management system according to a first exemplary embodiment;

FIG. 2 is a block diagram illustrating an exemplary electrical configuration of a print management apparatus according to the first exemplary embodiment;

FIG. 3 is a diagram illustrating a UI display of the amounts of spoilage, according to a comparison example;

FIG. 4 is a block diagram illustrating an exemplary functional configuration of a print management apparatus according to the first exemplary embodiment;

FIG. 5 is a diagram illustrating exemplary UI displays of the amounts of spoilage, according to an exemplary embodiment;

FIG. 6 is a diagram illustrating different exemplary UI displays of the amounts of spoilage, according to an exemplary embodiment;

FIG. 7 is a flowchart of exemplary processes performed by using a print management program according to the first exemplary embodiment;

FIG. 8 is a diagram illustrating an exemplary job management screen according to an exemplary embodiment;

FIG. 9 is a diagram for describing a job association process according to an exemplary embodiment; and

FIG. 10 is a flowchart of exemplary processes performed by using a print management program according to a second exemplary embodiment.

### DETAILED DESCRIPTION

Referring to the drawings, exemplary embodiments for carrying out the present disclosure will be described in detail below.

### First Exemplary Embodiment

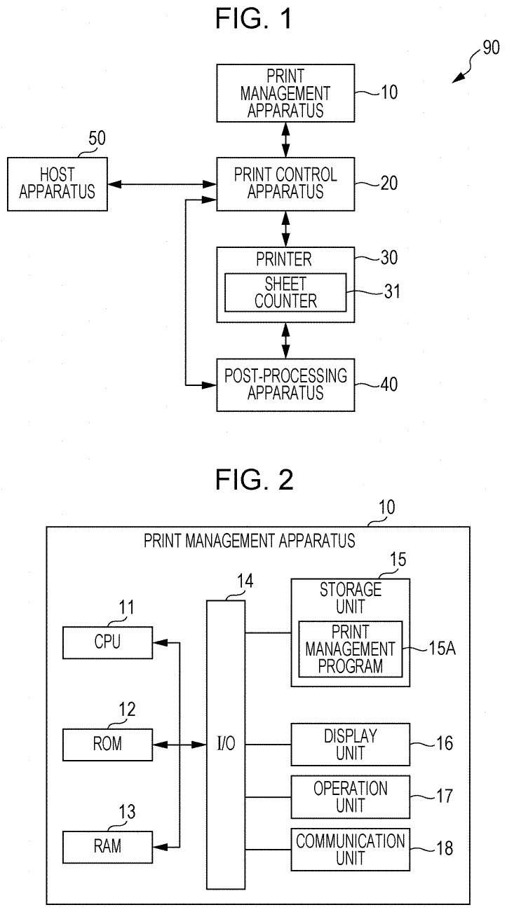

FIG. 1 is a diagram illustrating an exemplary configuration of a print management system 90 according to a first exemplary embodiment.

As illustrated in FIG. 1, the print management system 90 according to the first exemplary embodiment includes a print management apparatus 10, a print control apparatus 20, a printer 30, a post-processing apparatus 40, and a host apparatus 50.

The print management apparatus 10 is connected to the print control apparatus 20 over a network. Examples of the network include the Internet, a local area network (LAN), and a wide area network (WAN). The print management apparatus 10 receives input of jobs, and instructs the print control apparatus 20 to perform printing in accordance with the received jobs. Such a job indicates a unit of print process. For example, one job indicates print data for one file that is to be printed. The number of pages contained in one file is any, that is, equal to or more than one. That is, one file corresponding to one job may be constituted, for example, by one page or by 1000 pages. The number of pages contained in one file may be determined in advance or may be set by a user when appropriate.

The print control apparatus 20 is connected to the printer 30 over a network. There may be one or more connected printers 30. The print control apparatus 20 has a function of controlling the operations of a print process performed by the printer 30.

The printer 30 is a so-called continuous form printer which performs printing on a continuous sheet such as a roll sheet. The printer 30 includes a sheet counter 31. When the continuous sheet is transported in the sheet transport direction, the sheet counter 31 is used to measure the distance from the transport start position which is used as a reference (the count value=0 m). In the first exemplary embodiment, the print control apparatus 20 and the printer 30 are formed as separate units. Alternatively, the print control apparatus 20 and the printer 30 may be formed as an integrated unit.

To assure printing with stable image quality, the printer 30 waits at a start of printing until the transport rate of the continuous sheet reaches a predetermined rate. Then, the printer 30 starts printing a job. This produces a loss part, which is not used in the printing, of the continuous sheet. In addition, at a stop of printing, inertial transport, over a predetermined distance, of the continuous sheet is performed after the stop instruction. Similarly, this produces a loss part. That is, the printer 30 produces loss parts structurally before and after printing.

The print control apparatus 20 is connected to the post-processing apparatus 40 over a network. There may be one or more connected post-processing apparatuses 40. The print control apparatus 20 has a function of controlling the post-processing operations of the post-processing apparatus 40.

The post-processing apparatus 40 includes, for example, a processing apparatus, an after-process apparatus, and a cutting apparatus. For example, the processing apparatus performs processing, such as coating with varnish for suppressing attachment of flaws and dirt on the print surface of a recording medium (hereinafter referred to as a “sheet”) such as paper on which the printer 30 performs printing. The after-process apparatus performs processes such as a process of binding sheets of the body, which are folded so as to be arranged according to the page sequence, and then attaching a front cover to make the sheets in the form of a book. For example, the cutting apparatus performs processes such as cutting the margins of a book obtained through the bookbinding, and then finishing it in a predetermined size. The post-processing apparatus 40 may be connected to the printer 30 over a network.

The print control apparatus 20 is connected to the host apparatus 50 over a network. The host apparatus 50 manages all jobs received by the print management apparatus 10.

The print management apparatus 10 receives, through the print control apparatus 20, various types of information about the operations of the printer 30, and manages the operational state and the throughput of the printer 30. The print management apparatus 10 transmits, to the printer 30 through the print control apparatus 20, various instructions, such as an instruction to operate the printer 30, an instruction to stop the printer 30, and an instruction to make settings of operations of the printer 30.

The print management apparatus 10 receives, through the print control apparatus 20, various types of information about the operations of the post-processing apparatus 40, and manages the operational state and the throughput of the post-processing apparatus 40. The print management apparatus 10 transmits, to the post-processing apparatus 40 through the print control apparatus 20, various instructions, such as an instruction to operate the post-processing apparatus 40, an instruction to stop the post-processing apparatus 40, and an instruction to make settings of operations of the post-processing apparatus 40.

FIG. 2 is a block diagram illustrating an exemplary electrical configuration of the print management apparatus 10 according to the first exemplary embodiment.

As illustrated in FIG. 2, the print management apparatus 10 according to the first exemplary embodiment includes a central processing unit (CPU) 11, a read only memory (ROM) 12, a random access memory (RAM) 13, an input/output interface (I/O) 14, a storage unit 15, a display unit 16, an operation unit 17, and a communication unit 18.

For example, a general-purpose computer, such as a server or a personal computer (PC), is used as the print management apparatus 10 according to the first exemplary embodiment.

The CPU 11, the ROM 12, the RAM 13, and the I/O 14 are connected to each other through a bus. The functional units including the storage unit 15, the display unit 16, the operation unit 17, and the communication unit 18 are connected to the I/O 14. The functional units are capable of communicating with the CPU 11 through the I/O 14.

The CPU 11, the ROM 12, the RAM 13, and the I/O 14 constitute a controller. The controller may be formed as a sub-controller controlling some of the operations of the print management apparatus 10, or may be formed as a part of the main controller controlling the operations of the entire print management apparatus 10. For example, an integrated circuit of large scale integration (LSI) or the like, or an integrated circuit (IC) chipset is used as a part or the entirety of each block of the controller. An individual circuit may be used as each block described above, or a circuit obtained through integration of a part or the entirety of the block may be used. The blocks described above may be provided as an integrated unit, or some of the blocks may be provided separately. A part of each block described above may be provided separately. Integration of the controller is not limited to LSI, and a dedicated circuit or a general-purpose processor may be used.

For example, a hard disk drive (HDD), a solid state drive (SSD), or a flash memory is used as the storage unit 15. The storage unit 15 stores a print management program 15A for implementing a print management function according to the first exemplary embodiment. The print management program 15A may be stored in the ROM 12.

For example, the print management program 15A may be installed in advance in the print management apparatus 10. The print management program 15A, which is stored in a nonvolatile non-transitory storage medium or is distributed over a network, may be installed in the print management apparatus 10 when appropriate. Examples of a nonvolatile non-transitory storage medium may include a compact disc read only memory (CD-ROM), a magneto-optical disk, an HDD, a digital versatile disc read only memory (DVD-ROM), a flash memory, and a memory card.

For example, a liquid crystal display (LCD) or an organic electro luminescence (EL) display is used as the display unit 16. The display unit 16 may be integrated with a touch panel. For example, the operation unit 17 is provided with input-operation devices, such as a keyboard and a mouse. The display unit 16 and the operation unit 17 receive various instructions from a user of the print management apparatus 10. The display unit 16 displays various types of information, such as the result of a process, which is performed in accordance with an instruction received from a user, and notification to a process.

The communication unit 18, which is connected to a network, such as the Internet, a LAN, or a WAN, is capable of communicating with the print control apparatus 20 over the network. The communication over a network may be wired or wireless.

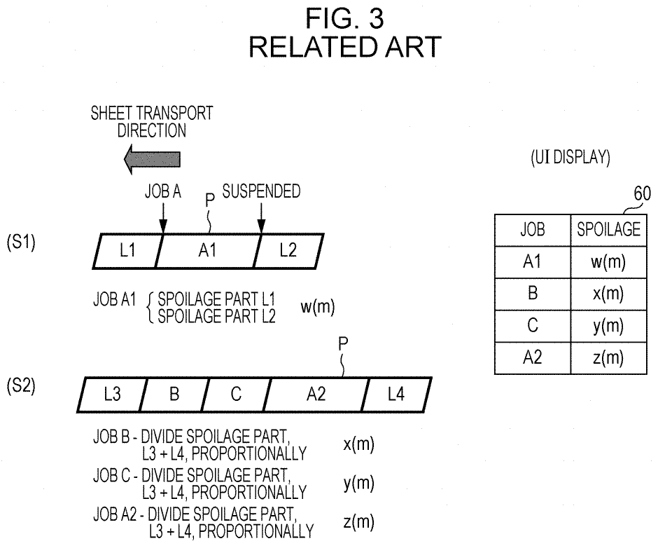

As described above, suspension of printing of a job on a continuous sheet causes the job to be divided, and the spoilage is determined only for each division. Referring to FIG. 3, a user interface (UI) display of the amounts of spoilage, which is made in the case where printing of a job is suspended, will be described specifically.

FIG. 3 is a diagram illustrating a UI display of the amounts of spoilage according to a comparison example.

In (S1), when interrupt printing is received while job A is being printed on a continuous sheet P, the printing of job A is suspended, causing transport of the continuous sheet P to be stopped temporarily. At that time, a division before the suspension of job A is represented by job A1. A spoilage part L1 and a spoilage part L2 are produced for job A1. The spoilage part L1 is spoilage before printing of job A1. The spoilage part L2 is spoilage after printing of job A1. In the comparison example in FIG. 3, the sheet counter 31 is used to calculate, as w (m), the total of the length of the spoilage part L1 and that of the spoilage part L2.

In (S2), interrupt printing, job B and job C, is performed on the continuous sheet P. Further, job A2 is printed subsequently to job C. Job A2 represents a division after the suspension of job A. That is, job A is divided into job A1 and job A2 due to the interrupt printing, job B and job C. A spoilage part L3 and a spoilage part L4 are produced for job B, job C, and job A2. The spoilage part L3 is spoilage before printing of job B. The spoilage part L4 is spoilage after printing of job A2. In the comparison example in FIG. 3, in calculation of the amounts of spoilage, job A1 and job A2 are regarded as separate jobs. The total of the length of the spoilage part L3 and that of the spoilage part L4 is divided proportionally among job B, job C, and job A2. As a result, the amount of spoilage of job B is calculated as x (m). The amount of spoilage of job C is calculated as y (m). The amount of spoilage of job A2 is calculated as z (m).

A UI display 60 in FIG. 3 displays the amounts of spoilage of job A1, job B, job C, and job A2, and only the partial amounts of spoilage of job A are determined. In this case, it is difficult to get information about the amount of spoilage of job A at a glance, resulting in complicated cost management. Therefore, it is desirable to get information about the amount of spoilage for each job at a glance.

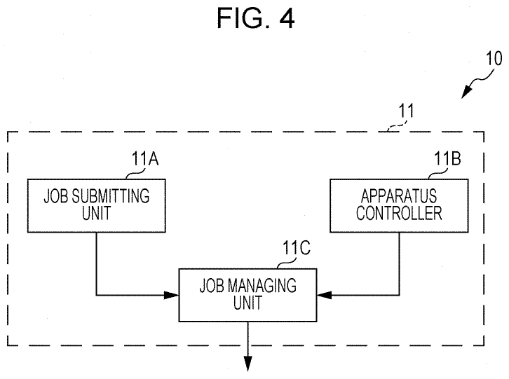

The CPU 11 of the print management apparatus 10 according to the first exemplary embodiment writes the print management program 15A, which is stored in the storage unit 15, on the RAM 13 for execution, functioning as the units in FIG. 4. The CPU 11 corresponds to an exemplary processor.

FIG. 4 is a block diagram illustrating an exemplary functional configuration of the print management apparatus 10 according to the first exemplary embodiment.

As illustrated in FIG. 4, the CPU 11 of the print management apparatus 10 according to the first exemplary embodiment functions as a job submitting unit 11A, an apparatus controller 11B, and a job managing unit 11C.

The job submitting unit 11A according to the first exemplary embodiment submits a job received from a person (operator) in charge of operation.

The apparatus controller 11B according to the first exemplary embodiment communicates with the print control apparatus 20 and controls the operations of the print control apparatus 20. The apparatus controller 11B obtains the count value of the sheet counter 31 from the print control apparatus 20.

When printing of a job, which is being performed by the printer 30 on a continuous sheet, is suspended and the job is divided into multiple divisions, the job managing unit 11C according to the first exemplary embodiment outputs the amount of spoilage for the first division of the job before suspension. When the second division of the job after suspension is printed, the job managing unit 11C outputs, as the amount of spoilage of the job, the total of the amount of spoilage for the second division and that for the first division. The spoilage indicates loss parts which are not used in printing, and is also called waste. The amount of spoilage is represented as the length (or area) of the loss parts described above. The amount of spoilage, which depends on print job conditions (for example, color, black and white, the print speed, and whether or not post-processing is to be performed), varies depending on each job. The suspension of a job occurs for example, due to interruption by another job.

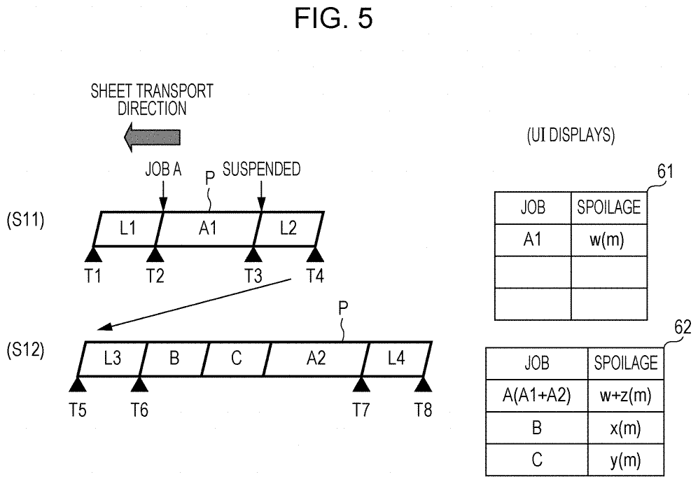

Referring to FIG. 5, UI displays of the amounts of spoilage, which are made in the case where printing of a job is suspended due to interruption by another job, will be described specifically.

FIG. 5 is a diagram illustrating exemplary UI displays of the amounts of spoilage according to the first exemplary embodiment.

In (S11), as in the comparison example in FIG. 3, when interrupt printing is received during printing of job A on a continuous sheet P, the printing of job A is suspended, causing transport of the continuous sheet P to be stopped temporarily. The first division of job A before suspension is represented by job A1. The amount of spoilage for job A1 is represented as the length, which is determined by using a first transport start position T1 and a first transport end position T4, minus the length of the sheet part which is used in printing of job A1.

The first transport start position T1 is a position at which transport of the continuous sheet P starts. The first transport end position T4 is a position at which transport of the continuous sheet P ends. The length of the sheet part used in printing of job A1 is determined by using a first print start position T2 and a first print end position T3. The first print start position T2 is a position at which printing of job A1 starts. The first print end position T3 is a position at which printing of job A1 ends. The first transport start position T1, the first transport end position T4, the first print start position T2, and the first print end position T3 are measured by using the sheet counter 31.

That is, the amount of spoilage for job A1 is the total length of the length of a spoilage part L1 and that of a spoilage part L2. The spoilage part L1 is spoilage before printing of job A1. The spoilage part L2 is spoilage after printing of job A1. In the example in FIG. 5, the sheet counter 31 is used to calculate, as w (m), the total of the length of the spoilage part L1 and that of the spoilage part L2.

In (S12), as in the comparison example in FIG. 3, interrupt printing, job B and job C, is performed on the continuous sheet P. Then, job A2 is printed subsequently to job C. Job A2 indicates a division after suspension of job A. That is, job A is divided into job A1 and job A2 due to the interrupt printing, job B and job C. Job B and job C correspond to exemplary different jobs. The number of different jobs is not limited to two, and may be any as long as the number is one or more. The second division after suspension of job A is represented by job A2. The amount of spoilage for job A2 is represented as the length obtained by dividing, proportionally among job B, job C, and job A2, the length, which is determined by using a second transport start position T5 and a second transport end position T8, minus the length of the sheet part used in printing of job B, job C, and job A2.

The second transport start position T5 is a position at which transport of the continuous sheet P restarts. The second transport end position T8 is a position at which transport of the continuous sheet P ends. The length of the sheet part used in printing of job B, job C, and job A2 is determined by using a second print start position T6 and a second print end position T7. The second print start position T6 is a position at which printing of job B starts. The second print end position T7 is a position at which printing of job A2 ends. The second transport start position T5, the second transport end position T8, the second print start position T6, and the second print end position T7 are measured by using the sheet counter 31.

That is, the amount of spoilage for job B, job C, and job A2 is the total of length of a spoilage part L3 and that of a spoilage part L4. The spoilage part L3 is spoilage before printing of job B. The spoilage part L4 is spoilage after printing of job A2. In the example in FIG. 5, in calculation of the amounts of spoilage, the total of the length of the spoilage part L3 and that of the spoilage part L4 is divided proportionally among job B, job C, and job A2. As a result, the amount of spoilage of job B is calculated as x (m). The amount of spoilage of job C is calculated as y (m). The amount of spoilage of job A2 is calculated as z (m).

A UI display 61 in FIG. 5 displays the amount of spoilage of job A1. A UI display 62 displays the amounts of spoilage of job A, job B, and job C. As the amount of spoilage of job A, the total length of the amount of spoilage of job A1, w (m), and the amount of spoilage of job A2, z (m), is displayed. Thus, information about the amount of spoilage for each job is got at a glance.

Association between job A1 and job A2 is made, for example, on the basis of the job name, the page number, or the like. That is, if the job name of job A1 is the same as that of job A2, job A1 is associated with job A2 as the same job A. If the first page number of job A2 follows the last page number of job A1 consecutively, job A1 is associated with job A2 as the same job A. Job A1 may be associated with job A2 as the same job A through a user operation.

The amount of spoilage for job A2 may be represented as the length, which is determined by using the second transport end position T8 and the second print end position T7, in the length, which is determined by using the second transport start position T5 and the second transport end position T8, minus the length of the sheet part used in printing of job B, job C, and job A2. That is, the amount of spoilage for job A2 may be represented as the length of the spoilage part L4. The amounts of spoilage for job B and job C are calculated, for example, by dividing the length of the spoilage part L3 proportionally between job B and job C.

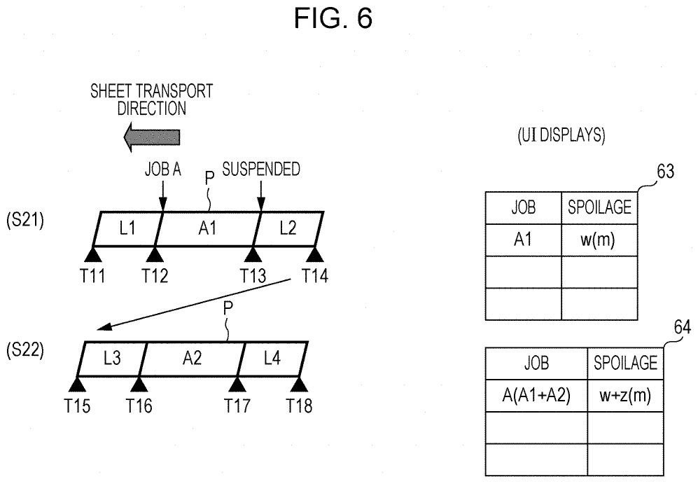

Referring to FIG. 6, UI displays of the amounts of spoilage, which are made in the case where printing of a job is suspended due to an event other than interruption by a different job, will be described specifically. The suspension in this case occurs due to a user operation on the printer 30, the printer 30 running out of consumables, the printer 30 running out of a sheet, or an error of the printer 30. The suspension may occur due to adjustment printing. The adjustment printing described herein means printing for adjusting the printer 30 or the print control apparatus 20 which controls the operations of the printer 30. In the adjustment printing, for example, a test pattern including the cyan, magenta, yellow, and black (CMYK) colors is printed. The suspension will be described below as suspension due to a user operation or the like.

FIG. 6 is a diagram illustrating different exemplary UI displays of the amounts of spoilage according to the first exemplary embodiment.

In (S21), as in the example in FIG. 5, a user operation or the like during printing of job A on a continuous sheet P suspends the printing of job A, causing transport of the continuous sheet P to be stopped temporarily. The amount of spoilage for job A1, indicating the first division, is represented as the length, which is determined by using a first transport start position T11 and a first transport end position T14, minus the length of the sheet part used in printing of job A1.

The first transport start position T11 is a position at which transport of the continuous sheet P starts. The first transport end position T14 is a position at which transport of the continuous sheet P ends. The length of the sheet part used in printing of job A1 is determined by using a first print start position T12 and a first print end position T13. The first print start position T12 is a position at which printing of job A1 starts. The first print end position T13 is a position at which printing of job A1 ends. The first transport start position T11, the first transport end position T14, the first print start position T12, and the first print end position T13 are measured by using the sheet counter 31.

That is, the amount of spoilage for job A1 is the total of the length of a spoilage part L1 and that of a spoilage part L2. The spoilage part L1 is spoilage before printing of job A1. The spoilage part L2 is spoilage after printing of job A1. In the example in FIG. 6, the sheet counter 31 is used to calculate, as w (m), the total of the length of the spoilage part L1 and that of the spoilage part L2.

In (S22), printing of job A on the continuous sheet P restarts and the remaining division, job A2, is printed. Job A2 indicates a division after suspension of job A. That is, job A is divided into job A1 and job A2 due to the user operation or the like. The amount of spoilage for job A2, which indicates the second division, is represented as the length, which is determined by using a second transport start position T15 and a second transport end position T18, minus the length of the sheet part used in printing of job A2.

The second transport start position T15 is a position at which transport of the continuous sheet P restarts. The second transport end position T18 is a position at which transport of the continuous sheet P ends. The length of the sheet part used in printing of job A2 is determined by using a second print start position T16 and a second print end position T17. The second print start position T16 is a position at which printing of job A2 starts. The second print end position T17 is a position at which printing of job A2 ends. The second transport start position T15, the second transport end position T18, the second print start position T16, and the second print end position T17 are measured by using the sheet counter 31.

That is, the amount of spoilage for job A2 is the total of the length of a spoilage part L3 and that of a spoilage part L4. The spoilage part L3 is spoilage before printing of job A2. The spoilage part L4 is spoilage after printing of job A2. In the example in FIG. 6, the amount of spoilage of job A2 is calculated as z (m).

A UI display 63 in FIG. 6 displays the amount of spoilage for job A1. A UI display 64 displays the amount of spoilage for job A. As the amount of spoilage of job A, the total of the amount of spoilage of job A1, w (m), and the amount of spoilage of job A2, z (m), is displayed. Thus, information about the amount of spoilage for each job is got as a glance.

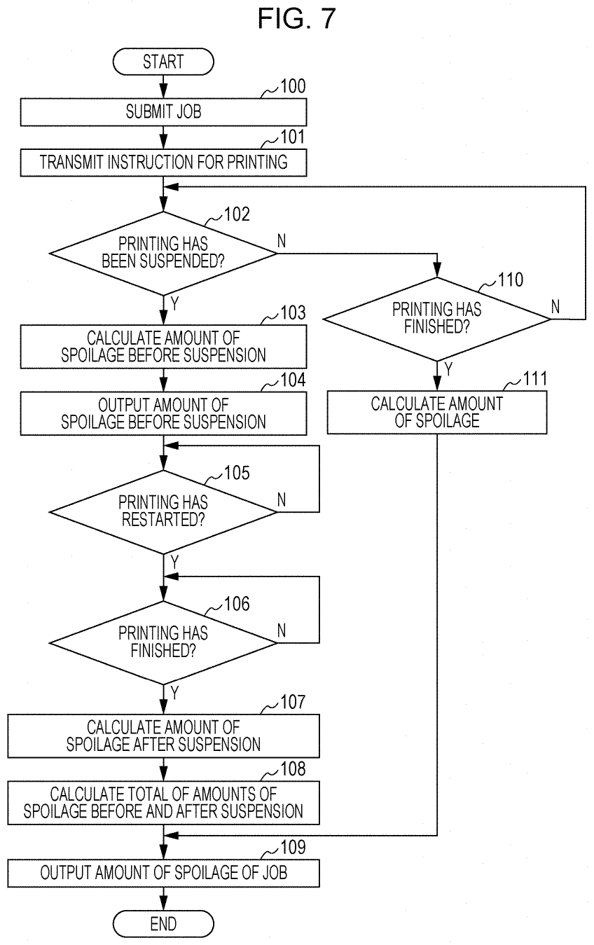

Referring to FIG. 7, operation of the print management apparatus 10 according to the first exemplary embodiment will be described.

FIG. 7 is a flowchart of exemplary processes performed by using the print management program 15A according to the first exemplary embodiment.

In response to an instruction to output the amount of spoilage for each job, the print management apparatus 10 activates the print management program 15A, and performs the steps described below.

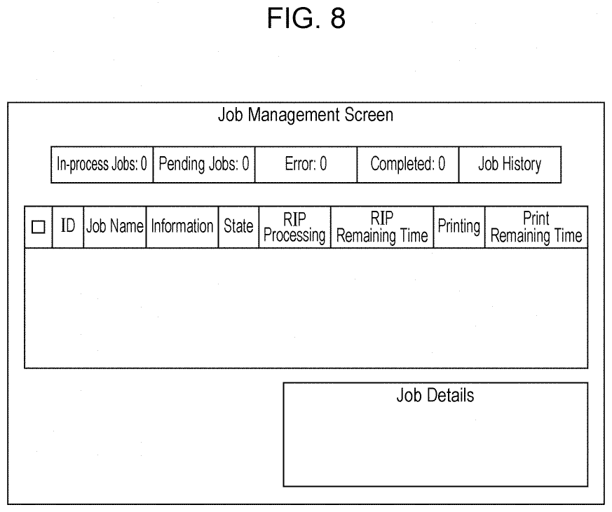

In step 100 in FIG. 7, the job submitting unit 11A submits a job to the job managing unit 11C. The submitted job is managed, for example, by using a job management screen illustrated in FIG. 8.

FIG. 8 is a diagram illustrating an exemplary job management screen according to the first exemplary embodiment.

On the job management screen in FIG. 8, jobs submitted by the job submitting unit 11A are registered, and the states of the jobs are managed until completion of the jobs.

In step 101, the job submitting unit 11A notifies the job managing unit 11C of an instruction to print the job submitted in step 100.

In step 102, the job managing unit 11C determines, through the apparatus controller 11B, whether or not printing on the printer 30 has been suspended. If it is determined that the printing has been suspended (in the case of the positive determination result), the process proceeds to step 103. If it is determined that the printing has not been suspended (in the case of the negative determination result), the process proceeds to step 110.

In step 103, the job managing unit 11C calculates the amount of spoilage of the first division before suspension of the job, for example, as described by referring to FIG. 5 or 6. The amount of spoilage of the first division is calculated, for example, as w (m).

In step 104, the job managing unit 11C outputs, for example, to the display unit 16, the amount of spoilage of the first division which is calculated in step 103, for example, as illustrated in the UI display 61 in FIG. 5 or the UI display 63 in FIG. 6.

In step 105, the job managing unit 11C determines, through the apparatus controller 11B, whether or not printing on the printer 30 has restarted. If it is determined that the printing has restarted (in the case of the positive determination result), the process proceeds to step 106. If it is determined that the printing has not restarted (in the case of the negative determination result), the process waits in step 105.

In step 106, the job managing unit 11C determines, through the apparatus controller 11B, whether or not printing on the printer 30 has finished. If it is determined that the printing has finished (in the case of the positive determination result), the process proceeds to step 107. If it is determined that the printing has not finished (in the case of the negative determination result), the process waits in step 106.

In step 107, the job managing unit 11C calculates the amount of spoilage of the second division after suspension of the job, for example, as described by referring to FIG. 5 or 6. The amount of spoilage of the second division is calculated, for example, as z (m).

In step 108, the job managing unit 11C calculates the total of the amount of spoilage of the first division, which is calculated in step 103, and the amount of spoilage of the second division which is calculated in step 107. The total amount of spoilage is represented, for example, as w+z (m).

In step 109, the job managing unit 11C outputs, for example, to the display unit 16, the amount of spoilage, which is obtained in calculating the total in step 108, for example, as illustrated in the UI display 62 in FIG. 5 or the UI display 64 in FIG. 6. Then, the series of processes performed by using the print management program 15A end.

In contrast, in step 110, the job managing unit 11C determines, through the apparatus controller 11B, whether or not printing on the printer 30 has finished. If it is determined that the printing has finished (in the case of the positive determination result), the process proceeds to step 111. If it is determined that the printing has not finished (in the case of the negative determination result), the process returns to step 102, and the processes are performed repeatedly.

In step 111, the job managing unit 11C calculates the amounts of spoilage before and after printing of the job. Then, the process proceeds to step 109.

According to the first exemplary embodiment, even when printing of a job on a continuous sheet is suspended, information about the amount of spoilage for each job is got at a glance.

### Second Exemplary Embodiment

In a second exemplary embodiment, a form in which, in the case where suspension of printing of a job produces divisions of the job, the divisions are associated with each other by using host information, which is managed by a host apparatus, will be described.

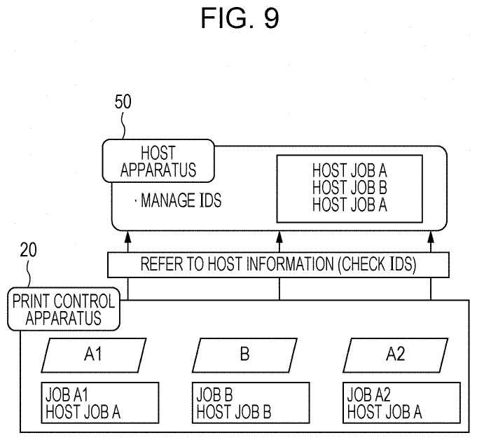

The apparatus configuration of the print management apparatus 10, which is described in the first exemplary embodiment, is applied also to the second exemplary embodiment. When job identification information, which is managed by the host apparatus 50, matches pieces of identification information of the first and second divisions obtained through division of a job, the job managing unit 11C according to the second exemplary embodiment associates the first division with the second division. The job association process will be described specifically by referring to FIG. 9.

FIG. 9 is a diagram for describing the job association process according to the second exemplary embodiment.

As illustrated in FIG. 9, the host apparatus 50 manages host information. The host information includes the identifications (IDs) of job A and job B. The IDs correspond to exemplary identification information. Even when one job is divided due to interruption or the like, the host apparatus 50 performs management in such a manner that the same ID is assigned to the divisions of the job. In the example in FIG. 9, when job A is divided into job A1 (the first division) and job A2 (the second division), for example, due to interruption by job B, the same ID, “host job A”, is assigned to job A1 and job A2. The ID, “host job B”, is assigned to job B.

In contrast, the print control apparatus 20 controls job A1 and job A2 as separate jobs. At that time, when the IDs of job A1 and job A2 match a job ID managed by the host apparatus 50, job A1 is associated with job A2.

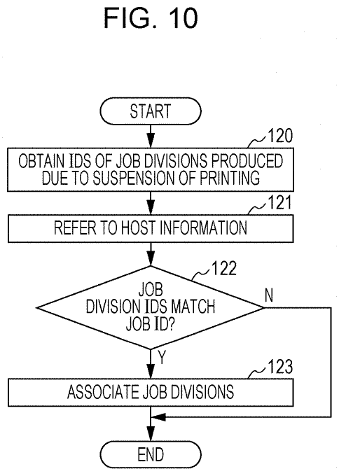

Referring to FIG. 10, operation of the print management apparatus 10 according to the second exemplary embodiment will be described.

FIG. 10 is a flowchart of exemplary processes performed by using the print management program 15A according to the second exemplary embodiment.

In step 120 in FIG. 10, the job managing unit 11C obtains, for example, the IDs of job A1 and job A2, which are illustrated in FIG. 9, through the apparatus controller 11B.

In step 121, the job managing unit 11C refers to the host information, which is managed by the host apparatus 50, on the basis of the IDs of job A1 and job A2 which are obtained in step 120.

In step 122, the job managing unit 11C determines whether or not the IDs of job A1 and job A2 match a job ID included in the host information. If it is determined that the IDs match a job ID (in the case of the positive determination result), the process proceeds to step 123. If it is determined that the IDs do not match a job ID (in the case of the negative determination result), the series of processes performed by using the print management program 15A end.

In step 123, the job managing unit 11C associates job Al with job A2. Then, the series of processes performed by using the print management program 15A end.

According to the second exemplary embodiment, even when one job is divided into divisions due to suspension of printing, the divisions are associated with each other. This enables management of the amount of spoilage for each job.

In the embodiments above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

A print management apparatus according to the exemplary embodiments is described by way of example. The exemplary embodiments may be provided in the form of a program for causing a computer to perform the functions of the units of the print management apparatus. The exemplary embodiments may be provided in the form of a computer-readable storage medium in which the program is stored.

In addition, the configuration of the print management apparatus described in the exemplary embodiments is exemplary, and may be changed as appropriate without departing from the gist of the present disclosure.

The process flow of the program described in the exemplary embodiments is also exemplary. Unnecessary steps may be deleted, new steps may be added, or the process order may be changed without departing from the gist of the present disclosure.

In the exemplary embodiments, the case in which execution of a program causes the processes according to the exemplary embodiments to be implemented through a software configuration by using a computer is described. However, this is not limiting. The exemplary embodiments may be implemented, for example, through a hardware configuration or through a combination of a hardware configuration with a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. A print management apparatus comprising:
a processor configured to,
when a job is divided into a plurality of divisions due to suspension of printing of the job, the suspension occurring while a printer configured to perform printing on a continuous sheet prints the job on the continuous sheet, output an amount of spoilage for a first division of the job, the first division being a division before the suspension, and,
when a second division of the job is printed, the second division being a division after the suspension, output, as an amount of spoilage for the job, a total of an amount of spoilage for the second division and the amount of spoilage for the first
wherein the amount of spoilage for the job indicates a total length of a loss part of the continuous sheet which is not used in the printing.

2. The print management apparatus according to claim 1,
wherein the suspension occurs due to interruption by a different job.

3. The print management apparatus according to claim 2,
wherein the amount of spoilage for the first division is represented as a first length minus a second length, the first length being determined by using a first transport start position and a first transport end position, the first transport start position being a position at which transport of the continuous sheet starts, the first transport end position being a position at which transport of the continuous sheet ends, the second length being a length of a part used in the printing of the first division, and
wherein the amount of spoilage for the second division is represented as a length obtained by dividing a third length proportionally between the second division and the different job, the third length being a fourth length minus a fifth length, the fourth length being determined by using a second transport start position and a second transport end position, the second transport start position being a position at which transport of the continuous sheet restarts, the second transport end position being a position at which transport of the continuous sheet ends, the fifth length being a length of a part used in printing of the different job and the second division.

4. The print management apparatus according to claim 2,
wherein the amount of spoilage for the first division is represented as a first length minus a second length, the first length being determined by using a first transport start position and a first transport end position, the first transport start position being a position at which transport of the continuous sheet starts, the first transport end position being a position at which transport of the continuous sheet ends, the second length being a length of a part used in printing of the first division, and
wherein the amount of spoilage for the second division is represented as a third length in a fourth length, the third length being determined by using a second transport end position and a print end position, the second transport end position being a position at which transport of the continuous sheet ends, the print end position being a position at which printing of the second division ends, the fourth length being a fifth length minus a sixth length, the fifth length being determined by using a second transport start position and the second transport end position, the second transport start position being a position at which transport of the continuous sheet restarts, the sixth length being a length of a part used in printing of the different job and the second division.

5. The print management apparatus according to claim 1,
wherein the suspension occurs due to any one of reasons, the reasons being a user operation on the printer, the printer running out of consumables, the printer running out of a sheet, and an error of the printer.

6. The print management apparatus according to claim 5,
wherein the amount of spoilage for the first division is represented as a first length minus a second length, the first length being determined by using a first transport start position and a first transport end position, the first transport start position being a position at which transport of the continuous sheet starts, the first transport end position being a position at which transport of the continuous sheet ends, the second length being a length of a part used in printing of the first division, and
wherein the amount of spoilage for the second division is represented as a third length minus a fourth length, the third length being determined by a second transport start position and a second transport end position, the second transport start position being a position at which transport of the continuous sheet restarts, the second transport end position being a position at which transport of the continuous sheet ends, the fourth length being a length of a part used in printing of the second division.

7. The print management apparatus according to claim 1,
wherein the processor is configured to, when identification information of the job matches identification information of the first division and identification information of the second division, the identification information of the job being managed by a host apparatus, associate the first division with the second division.

8. The print management apparatus according to claim 2,
wherein the processor is configured to, when identification information of the job matches identification information of the first division and identification information of the second division, the identification information of the job being managed by a host apparatus, associate the first division with the second division.

9. The print management apparatus according to claim 3,
wherein the processor is configured to, when identification information of the job matches identification information of the first division and identification information of the second division, the identification information of the job being managed by a host apparatus, associate the first division with the second division.

10. The print management apparatus according to claim 4,
wherein the processor is configured to, when identification information of the job matches identification information of the first division and identification information of the second division, the identification information of the job being managed by a host apparatus, associate the first division with the second division.

11. The print management apparatus according to claim 5,
wherein the processor is configured to, when identification information of the job matches identification information of the first division and identification information of the second division, the identification information of the job being managed by a host apparatus, associate the first division with the second division.

12. The print management apparatus according to claim 6,
wherein the processor is configured to, when identification information of the job matches identification information of the first division and identification information of the second division, the identification information of the job being managed by a host apparatus, associate the first division with the second division.

13. A non-transitory computer readable medium storing a program causing a computer to execute a process for print management, the process comprising:
when a job is divided into a plurality of divisions due to suspension of printing of the job, the suspension occurring while a printer configured to perform printing on a continuous sheet prints the job on the continuous sheet, outputting an amount of spoilage for a first division of the job, the first division being a division before the suspension, and,
when a second division of the job is printed, the second division being a division after the suspension, outputting, as an amount of spoilage for the job, a total of an amount of spoilage for the second division and the amount of spoilage for the first division,
wherein the amount of spoilage for the job indicates a total length of a loss part of the continuous sheet which is not used in the printing.

14. A print management apparatus comprising:
means for, when a job is divided into a plurality of divisions due to suspension of printing of the job, the suspension occurring while a printer configured to perform printing on a continuous sheet prints the job on the continuous sheet, outputting an amount of spoilage for a first division of the job, the first division being a division before the suspension, and
means for, when a second division of the job is printed, the second division being a division after the suspension, outputting, as an amount of spoilage for the job, a total of an amount of spoilage for the second division and the amount of spoilage for the first division,
wherein the amount of spoilage for the job indicates a total length of a loss part of the continuous sheet which is not used in the printing.
